(19) United States
(12) Patent Application Publication
(10) Pub. No.: US 2016/0283764 A1
(43) Pub. Date: Sep. 29, 2016

(54) Method and System for Delivery of Digital Media via Optical Machine-Readable Data Representation

(71) Applicants: Brad Benson, Maplewood, MN (US); Peter Bodurtha, Minneapolis, MN (US); Juile Bodurtha, Minneapolis, MN (US); Guillermo Gonzalez-Moriyon Hernandez, Gijon (ES)

(72) Inventors: Brad Benson, Maplewood, MN (US); Peter Bodurtha, Minneapolis, MN (US); Juile Bodurtha, Minneapolis, MN (US); Guillermo Gonzalez-Moriyon Hernandez, Gijon (ES)

(21) Appl. No.: 14/672,201

(22) Filed: Mar. 29, 2015

(51) Int. Cl. G06K 7/14; G06F 17/30

(52) U.S. Cl. CPC G06K 7/1417; G06F 17/30879

(57) ABSTRACT

A method and system for distributing digital media by creating and presenting optical machine-readable data representation (OMDR) objects. Artists input digital media and associated data into an internet-based computer application storing data on a media system server. Once OMDR objects are created and displayed, users may acquire digital media via the optical recognition functions of a mobile computer application installed on a mobile device. Once the OMDR object is scanned, the mobile application communicates with a media system server configured to store, organize, validate and distribute digital media and associated data. This method allows artists, content-owners and their agents to distribute content digitally via OMDR objects instead of utility-focused distribution methods such as CDs, DVDs, books, online download or streaming subscription vendors. Specific applications and embodiments may include affixing QR codes facilitating automatic access to music files to band paraphernalia to sell together as a single item or posting QR codes permitting automatic access to music media files on large posters for public consumption.

### CROSS-REFERENCE TO RELATED APPLICATIONS

The present application claims priority from application No. 61/967,910 filed Mar. 31, 2014.

### TECHNICAL FIELD

The present invention relates to content provision and acquisition, and more particularly to digital content distribution technology.

### BACKGROUND ART

U.S. Patent Documents

| | | | | | Pages, Columns, |
|---|---|---|---|---|---|
| | | | | | Lines where |
| | | | | | Relevant |
| | | | | Name of Patentee | Passages or |
| Cite | | Kind | Publication | or Applicant of | Relevant Figures |
| No | Pat. No. | Code | Date | cited Document | Appear |
| 1 | US 20120311723 | A1 | Dec. 6, 2012 | Google Inc. | Page 14, Claims |
| | | | | | 1, 2, 3 and 9 |
| 2 | US 20100325182 | A1 | Dec. 23, | Howard Ganz | Page 1, |
| | | | 2010 | | paragraphs 0013, |
| | | | | | 0014, 0015, 0016 |
| 3 | US 20080004978 | A1 | Jan. 3, 2008 | Rothschild Trust | Page 1, |
| | | | | Holding, Llc | paragraph 0016, |
| | | | | | 0018 |
| 4 | U.S. Pat. No. 8,280,988 | B1 | Oct. 2, 2012 | Amazon | Column 2, line 31 |
| | | | | Technologies, | Column 2, lines |
| | | | | Inc. | 38-51 |
| 5 | U.S. Pat. No. 7,756,467 | B2 | Jul. 13, | Sony Ericsson | Column 1, lines |
| | | | 2010 | Mobile | 45-51 |
| | | | | Communications | |
| | | | | Ab | |
| 6 | U.S. Pat. No. 8,385,912 | B2 | Feb. 26, | Gofigure Media, | Column 2, lines |
| | | | 2013 | Llc | 5-20 |
| 7 | U.S. Pat. No. 8,589,505 | B2 | May 27, | Texas | FIG. 2 |
| | | | 2004 | Instruments | FIG. 3 |
| | | | | Incorporated | Column 2, lines |
| | | | | | 14-33 |

Media including music or books are currently delivered in either physical or digital form. Traditionally, physical formats have been the dominant form of content delivery, with users gaining access to music, video or texts through vinyl records, compact discs, DVDs or paper books. For each of these items, their value lies primarily in the content they deliver and any intrinsic value for the item is secondary. Increasingly, content is delivered digitally, avoiding physical delivery entirely through the download or streaming of music, video or e-books from the internet or other networks. Digital delivery has many advantages over physical formats in that it does not require the user to carry any physical item to access content other than a computer, tablet, mobile phone or other device. Furthermore, sale and delivery processes are more efficient as users no longer have to visit a physical store or wait for an order to ship to use the content.

Despite the many advantages of purely digital content delivery, disadvantages severely limit the utility and profitability of digital content distribution for content owners, especially smaller independent artists. These content owners often have limited distribution networks and advertising resources and interact most directly with potential new users of their content at events including concerts, film screenings and author speaking engagements, among others, where they often have only physical distribution formats, including books, CDs, DVDs, or vinyl records, available for sale. As digital distribution including digital files like mp3s and streaming services increase as a share of media consumption, these artists increasingly have difficulty using these new formats to connect with users, which is a reason small, independent artists still rely heavily on older formats such as CDs—there really is no better alternative. Thus, the lack of viable digital distribution methods limits the ability of many content owners to encourage the sale of their content at this point of high-leverage, thus limiting their ability to grow their user network. Download cards, stickers and other items with download codes have attempted to address this deficiency, but it has become clear that these methods have failed to address the digital distribution problem. Despite the wide availability of download cards, they remain very uncommon in practice because the process of putting a long code into a web portal is actually less efficient that loading a CD into a computer or simply opening a physical book. Furthermore, these digital solutions have already been surpassed by subscription services, including those that facilitate digital downloads to computers, e-readers and streaming services.

Services that offer media downloads for a fee similarly lack the immediacy of a physical format distribution method. To buy digital media through an online vendor, one must submit payment information to the vendor, which takes time and a willingness to give a vendor sensitive personal information. Many users may simply choose that it is not worth the time and effort to create accounts, input payment information and download the media, thus the artist loses vital sales.

Offering content through a subscription streaming service is the only distribution method available that has the immediacy of traditional formats such as CDs, DVDs or books, but has many drawbacks for both the user and the artist, especially independent artists. At an event, the artist cannot possibly know which subscription service a user has subscribed to, if they have subscribed to one at all, meaning that there is no way to direct them to a streaming access point for their content. The only alternative is to post the media online for free, which results in no profit for the artist. Furthermore, subscription services pay artists very little compared to prior physical distribution formats, resulting in lower levels of income—this problem is so severe that a number of popular U.S. artists have recently pulled their music from all major subscription streaming services.

Small or independent artists with limited distribution capacity have much to gain from communicating directly with users interested in their music—they often lack the resources to advertise to the public broadly. None of the above proposed digital solutions do anything to solve the enduring problem of physical formats such as CDs or DVDs, in that there is no way for the artist and the user to leverage the system of purchase to communicate with fans of their products in the future.

It is apparent that a need exists to provide artists with a digital distribution method that matches the immediate utility of traditional media formats for users with the ability for artists to grow their networks through successful, interactive digital sales.

Several methods have been previously proposed to improve on digital media distribution methods currently available and none of them represent a viable solution to the said problems listed above.

Methods that allow for digital content access via indicia on CDs or DVDs are too narrow in their application, limiting users to content they have already purchased in physical form and forcing them to validate purchases with a third-party vendor. U.S. Pat. No. 8,589,505 specifies a system and method for attaching indicia to a physical item, including reading a barcode label, but specifies that the content that may be retrieved from the indicia is a digital version of the content contained in the physical format (e.g. a CD or DVD). Likewise, patent application US20120311723 expands on the system and method of U.S. Pat. No. 8,589,505 to apply to digital media streaming, yet nonetheless proposes a system where the transfer and authentication of digital media linked to physical media formats. These methods and systems require the inclusion of physical formats and third-party subscription services of some form, thus failing to solve the problem of figuring out which paid subscription service users should be directed to (if the user has one at all) and still forcing them to buy content in a traditional distribution format in the first place.

Other methods that move away from physical distribution formats do not provide enough immediacy to consumers to make them preferable to traditional physical formats such as CDs or DVDs. Patent application US20100325182 proposes a method of allowing users to take a code from one website and allow users to type the said code into another web portal to download multimedia. For the user, this method is little different from a download card, where the requirement of typing in a code online is insufficiently immediate to comprise a meaningful improvement. Patent application US20080004978 relies entirely on identification codes already extant on physical merchandise and direction to third-party vendors for purchase. Under this system, artists are limited to traditional distribution formats such as CDs or books. Furthermore, they have to go through the steps of validating and purchasing the digital media through an online distribution service, presenting barriers to distribution. Neither of these methods contains any avenue for continued communication and the artist lacks any presence in the transaction. U.S. Pat. No. 8,385,912 forces users to purchase content through an online service to acquire digital media, thus rendering it an aspect of current download-type services.

Still other similar methods contain elements that make them impractical for solving the problems of an artist or content owner. U.S. Pat. No. 8,692,248 entails the use of a remote control to move data between computing devices, thus limiting its scope to simply moving data between devices. Further, the requirement of a proprietary controller makes the barrier to acquiring new content impossibly high for the user (they would have to have the controller to get the content). U.S. Pat. No. 8,280,988 relies on an eBook or e-reader device and the transfer is automated not by reading data representations or indicia, but rather an automated timer processes. Such inventions do not contain the elements necessary to solve the digital distribution problems of small or independent artists, content owners and their agents.

### SUMMARY OF THE INVENTION

The present invention and its embodiments provide a method and system for producing optical machine-readable data representation (OMDR) objects, including QR codes, representing digital content which, when displayed, facilitate the distribution or sale of images, music, video or other digital content to users. The novel result of this invention and its embodiments is to permit artists, content owners, their agents, and digital content users, the option to forsake popular digital content distribution services, instead distributing digital content directly to users by displaying OMDR objects in a manner of their choosing.

The method and system of the present invention comprise an internet-based computer application, a mobile device-based mobile application and a media system server, each of which interact with OMDR objects in a substantial way. The media system server is a central computer, including any number of servers, configured to store digital content, track content usage, distribute content to the computer application and mobile application and facilitate communication from the computer application to the mobile application.

The computer application is an internet-hosted application used by artists, content owners and their agents to prepare content for upload to the media system server. The computer application accepts digital content and associated data from the artist, content owner or their agents. This data is used by the media system server to generate ticket IDs, which are used to create OMDR objects that may be displayed to users.

A mobile application installed on a mobile computing device recognizes objects provided via the computer application and the media system server to access digital content from the said media system server, allowing the user to access the digital content associated with an OMDR object.

The user, having acquired the ability to view an OMDR object from the artist, content owner or their agents, and having installed the mobile application on a mobile computing device, scans the OMDR object using the mobile application. When an OMDR object is recognized, the code associated with the object is sent to the media system server which validates the object against the list of all previously generated objects. If the object is determined to be valid, the associated digital content is sent to the mobile application and the object's usage count is updated to indicate it has been used, according to the limitations that may be imposed by the artist, content owner or their agents as described in embodiments of the present method and system. This count may be used to limit, prohibit or otherwise modify a user's ability to acquire digital content through that same OMDR object on multiple occasions or any number of other users to access the digital content via the object.

A mobile application shall also be configured to allow users to manage, play, view or otherwise interact with said digital content within the mobile application, or in conjunction with any other mobile application located on a mobile computer device or other connected computing devices.

A first embodiment of this method and system facilitates digital content access via multiple unique OMDR objects. OMDR object recognition and content acquisition is facilitated by mobile application software including an optical recognition function and a content management interface. This embodiment provides for the production of many unique OMDR objects, whereby each object is distinct from all other objects associated with the same digital content. The content owner or their agents may then manage the number of downloads or transmittals of digital content associated with each object, including the ability to limit access to a single computing device, or to a single user account. This embodiment of the invention allows the content owner to prevent digital content attached to a single OMDR object from being accessed by multiple users through the same object, thus providing substantial control over the distribution of their content. Unique objects are then to be displayed to users, including by affixing to a physical item or digital display, printing as part of an item or display or otherwise displaying in physical or digital form. For example, unique OMDR objects could be affixed by printing stickers and then sticking them to paraphernalia to be sold, printing the codes directly on the item or otherwise including the codes in the item design or artwork or graphics included therein. Upon purchase of the said physical item, the user uses the optical scanning capabilities of a mobile application on a mobile computing device to recognize the code and acquire authorization to access to the digital content, including by download to the mobile device.

Operation of this embodiment includes locating digital content files intended for distribution and uploading them to the media system server via the computer application, from which digital content may be accessed by the mobile computer application. OMDR objects associated with uploaded content are presented and any number of unique iterations of an OMDR object associated with the uploaded content are made available. Each object is attached or otherwise included with objects for sale or distribution. A user acquires an item including the OMDR object and scans it using a mobile computing application, either the application included in embodiments of this invention or otherwise compatible applications. If the user has already installed the mobile computer application on his or her mobile computing device, scanning the OMDR object results in automatic transfer or access to the digital content, which can then be recalled and managed via the mobile application. Once the scan has been completed, that OMDR object is associated with that user via any number of methods, including associating with a mobile device or a user account. An acquisition limitation is operationalized via usage and provisioning counts stored in the media system server and matched to preferences indicated by the artist, content owner or their agents via the computer application. When an object is validated, the media system server checks the identity of the user, including by their associated user ID. If the user ID of the mobile application submitting the token matches information stored in the media system server or usage counts are less than provisioning counts, the code is considered valid and the user is permitted to access the associated digital content. If either of these conditions is not met, access is denied. If the usage count is less than the provisioning count, the usage count is incremented.

A second embodiment includes any of the elements of the first embodiment of the present invention, with the exception that it facilitates multiple access of digital content associated with a singular OMDR object. In this embodiment, content is uploaded to the computer application where it is linked to a single OMDR object which may be printed or displayed once or any number of times, affixed to an item or items, or otherwise displayed in physical or digital form where users may access the OMDR object through the said mobile application. In an alternative embodiment, the method and system may be configured to limit downloads from a single, multi-use OMDR object to create usage patterns similar to the multiple unique OMDR objects described in the prior embodiment.

The operation of the second embodiment comprises the operation of the first embodiment allowing for multi-user access.

A third embodiment comprising the elements of the first embodiment where OMDR objects are attached or included in paraphernalia, including a button or clothing containing an artist's artwork, to be sold to users in any number of venues, including events, thereby distributing artist merchandise and digital content together as one item.

The operation of the third embodiment is identical to the first embodiment if many unique OMDR objects are employed, the second embodiment if iterations of a single object is employed.

A fourth embodiment comprising the elements of second embodiment includes presenting OMDR objects directly to users via a single printed or projected OMDR object or a digital representation of that object, inside an event space or otherwise in a public or private space where users may access the OMDR object at the content owner's or their agent's discretion.

The operation of the fourth embodiment comprises the operation of the second embodiment where users may freely scan an OMDR object presented openly from small and large distances in small or large print or digital display formats.

A fifth embodiment comprising elements of the second embodiment includes presenting OMDR objects directly to users via a single OMDR object at the discretion of the holder of the OMDR object. At their discretion, including in exchange for payment, OMDR object holders may display the object, including as an object on their mobile computing device, printed or otherwise displayed to users to allow acquisition of the digital content connected to that object. In this way, content owners and their agents may limit digital content distribution via this embodiment at their discretion.

The operation of the fifth embodiment comprises the operation of the second embodiment where the holder of a single iteration of the OMDR object hides the object until such time as they wish to display it to the user, including by requiring payment prior to displaying the object, thereafter the user may execute the operations of the second embodiment.

A sixth embodiment comprising elements of the second embodiment presenting an OMDR object as means for a promotional release of digital content.

The operation of the sixth embodiment comprises the operation of the second embodiment where no payment or other prerequisite is enforced prior to allowing users to acquire digital content associated with an OMDR object.

A seventh embodiment comprising elements of the first embodiment providing access to digital versions of content delivered as physical content, such as an OMDR object attached to or included with a traditional content delivery device, including DVDs, paper books or vinyl record.

Operation of the seventh embodiment comprises the operation of the first and third embodiments, where physical items containing or otherwise hosting the OMDR object may be sold or distributed from the content owner and their agents to users either directly or via a third party, including distributors, music stores, online stores or book stores. Users may buy items from third parties where they acquire both the physical host-item and the digital content represented in the OMDR object include therein, thereafter they may execute the operation described in the first embodiment.

An eighth embodiment comprising elements of any previously mentioned embodiments where the method of digital content access is the download of a computer file, including mp3s.

Operation of the eighth embodiment comprises any other embodiments wherein the user thereafter may transfer a data file between and within devices according to legal use.

A ninth embodiment comprising elements of any previously mentioned embodiments where the method of digital content access is a streaming service the user has access to whereby the digital content may be streamed or otherwise temporarily transferred. A form of this embodiment may use information entered into the mobile application or other computer applications existing on the mobile computing device to identify and redirect to the proper streaming service.

Operation of the ninth embodiment comprises all other embodiments wherein the user thereafter may access the digital content remotely but does not gain control of a computer file per se. Playing digital content via the mobile computing device represents a temporarily enabled communication between remotely stored content and the mobile computer application rather than a permanent transfer of data.

A tenth embodiment comprising elements of the first or second embodiments facilitating access to advertisements or coupons via an OMDR object attached to or printed on an promotional item, including event tickets and advertisements, via an OMDR object.

Operation of the tenth embodiment comprises any of the operations of other embodiments, wherein the OMDR object is displayed as part of an advertisement.

An eleventh embodiment comprising elements of any other listed embodiments, where after accessing content via OMDR recognition via the said mobile application on the said mobile computing device, the mobile application asks users to follow the content-provider per the instructions of the content provider, including joining a mailing list, joining an email list, or connecting with the content-provider on social networking services. In this way, the invention facilitates greater connection between content-providers and users and increases possibilities for future commerce with consumers who are already the most likely to be interested—those who were interested enough to acquire the digital content in the first place.

Operation of the eleventh embodiment allows the artist, content owner or their agents to enter relevant information identifying their social media sites and release appropriate access to those social media accounts to the said computer application or said mobile computer application. Once entered and connected, social media connection options are presented to the user who has acquired access to that content owner or their agents' digital content where the user may follow, like or otherwise connect with the content owner and their agents. Furthermore, users may elect to allow content owners and their agents to send customized messages to users who have accessed their content through an embodiment of this invention, which may be connected to other mobile applications on the user's mobile device, including their calendar and notes applications. Artists, content owners or their agents select the digital media for which they would like to send a message in the computer application (or the mobile application, in another embodiment), fill-in the text of the message which is then sent for display in the mobile applications or otherwise configured mobile devices of those who have previously accessed that mobile content and elected to receive said notifications. Users may display and read said notifications in the mobile computer application.

A twelfth embodiment, comprising any of the elements of prior embodiments wherein a method of accessing digital content without use of the mobile application or a mobile computing device is facilitated.

Operation of the twelfth embodiment includes the inclusion of an alpha-numeric code with the OMDR object, including by printing it on the object, and providing means, including on a website, for users to enter the code to access the digital content. Alternatively, recognition of OMDR objects via third-party mobile computer applications (such as QR readers) may redirect users to a web-based portal where the said alpha-numeric code may be entered to validate access to said digital content.

A thirteenth embodiment, comprising any of the elements of other embodiments wherein a button in the mobile application allows users to manually turn on and off the flash or other lighting apparatus attached to the said mobile device being used to recognize the OMDR object. Alternatively, the mobile application may be written to automatically turn the flash or other lighting apparatus on or off according to light sensors included in the device.

Operation of the thirteenth embodiment involves touching or otherwise toggling the virtual button on the mobile device screen to turn the flash or other lighting apparatus on or off. The light from this apparatus allows users to recognize OMDR objects in low-light settings, but allows them to not use the light when it is not warranted. An alternative embodiment, where the light turns on or off automatically, serves the same function however without the input or discretion of the user.

A fourteenth embodiment where the mobile application includes means for artists, content owners and their agents to upload and manage content, and otherwise manage their user account via the mobile application.

Operation of the fourteenth embodiment includes elements of any of the prior embodiments wherein the mobile application includes a content owner log-in function where any of the elements of the said computer application for content owners are executable within a mobile application, which may be one and the same as the said mobile application designed to recognize OMDR objects.

A fifteenth embodiment, where the media system server is configured to give OMDR objects an expiration date after which users may no longer access the associated digital content via the mobile application. This embodiment may be automatically configured as to give every object a definite expiration or be determined using the internet-based computer application, where artists may specify an expiration date as to prevent users from endlessly downloading content captured from a publicly displayed object.

Operation of the fifteenth embodiment includes configuration of the media system server to include an expiration timestamp associated with digital content. This embodiment may also include an element of the computer application configured to allow artists to input a date at which users may no longer use a single object or family of objects. When the user scans the object, the media system server checks to see if the expiration timestamp has passed. If the timestamp has not passed, the media system server may proceed to the next validation step or to permitting access. If the timestamp has passed, the media system server shall be configured to prohibit access to said digital content.

A sixteenth embodiment, wherein the media system server is configured to limit user access to digital content based on geographical location. Thus an artist may limit use to users within a particular geographical space, preventing images available publicly from being freely shared across the world via presentation of copied images on the internet. This embodiment thus aids the artist in controlling distribution of their content.

Operation of the sixteenth embodiment includes a geo-referenced location specified on the media system server, inputted through the internet-based computer application by the artist, content owner or their agent. When the object is scanned, the mobile application is configured to send its current geo-referenced location to the media system server where it is matched against the geo-referenced location associated with that object. If the geo-referenced location matches and all other limiting principles are met, access to the digital content is permitted. If the match fails, access is prohibited. This embodiment is of particular relevance to the second embodiment where free display of the OMDR object may result in relatively simple dissemination of OMDR objects on the internet.

A seventeenth embodiment, wherein the backend for the computer application and the mobile computer application are separate and are configured to communicate with each other and with their respective applications. This embodiment resolves security concerns related to locating artist information on the same media system server where requests for OMDR object authentication occurs.

Operation of the seventeenth embodiment includes configuring elements of any number of media system servers to host operations from the computer application and the mobile application separately. One media system server configuration, called the “run-time”, is configured to store content from the artists, validate OMDR objects, track object usage and distribute digital content to users through the mobile application. Another media system server configuration, called the “portal”, is configured to accept digital content and associated data from artists, content owners and their agents and use ticket IDs generated by the run-time to generate OMDR objects for display to users. Thus computer application operations are separated from mobile application operations.

An eighteenth embodiment including any elements of other said embodiments where online payment is required to acquire digital content after scanning an OMDR object with the mobile application.

Operation of an eighteenth embodiment includes connecting the media system server to a payment system to accept payment from the user as part of the content acquisition process. Alternatively, payment processes could be configured as part of the media system server. A user would scan the OMDR object with a mobile application enabled mobile device, and as part of the authentication process, the media system server would require valid payment credentials from the user. Once payment is validated, the digital content is made available to the user per the specifications included elsewhere in this patent.

A nineteenth embodiment where the functions of the computer application are included in a mobile application, permitting all content owner and user functions to be accessed via a single mobile computer application.

Operation of the nineteenth embodiment includes any of the elements of other embodiments, except where digital content and associated data are communicated to the media system server through a mobile application rather than an internet-based computer application. This embodiment allows the invention to function as a mobile-device only method and system.

In each embodiment, the method and system of the present invention represents an improvement upon methods or systems currently employed. OMDR objects included in merchandise effectively replace an item with no intrinsic value (a compact disc) with an item with intrinsic value (a button, t-shirt or other paraphernalia) while giving artists, content owners and their agents any number of ways to sell or distribute their digital content directly to users. Single objects presented at events (including large-format and smaller person-to-person presentations of OMDR objects) remove the need for physical items all together, while overcoming a main drawback of digital distribution by strongly encouraging the user to acquire the content while in contact with the artist, content owner or their agents. Access to digital content via OMDR objects included with advertisements or similar representations allow companies greater possibilities for customer interactions with their brand than traditional OMDR schemes.

Thus the reader will see that at least one embodiment of this method and system for distributing digital content provides a novel, dynamic method for artists, content owners and their agents to interact with content users, resulting in a system capable of fully replacing any and all present digital content distribution methods and dramatically expanding distribution possibilities for artists, content owners and their agents.

While the descriptions are specific about many embodiments of this invention, it should not be construed to limit the scope of the invention but rather provide evidence of its wide-ranging utility to an array of content producers, including musical artists, film producers, authors and advertisers.

### BRIEF DESCRIPTION OF THE DRAWINGS

The key features of the invention summarized above may be understood by reference to the appended drawings, though illustrations of the method and system represent possible embodiments and should not be considered as limiting the scope of the invention.

FIG. 1. A logic diagram of a method and system comprising the main embodiments described in this document.

FIG. 2. A logic diagram of an alternative embodiment of the method and system of the invention, where a user lacks a mobile device capable of acquiring the mobile application.

FIG. 3. An illustration of an example of the mobile computing device acquiring an OMDR object displayed on the exterior of a vinyl record jacket via the mobile application.

FIG. 4. An illustration of an embodiment of the invention where an OMDR object, in this case a QR code, is affixed to the back of a button, which may be sold as artist paraphernalia.

FIG. 5. An illustration of an embodiment of the invention where an OMDR object, in this case a QR code, is affixed to the front of a T-shirt, which may be sold as artist paraphernalia.

FIG. 6. An illustration of an embodiment of the invention where an OMDR object, in this case a QR code, is affixed or otherwise included on the front cover of a lyric booklet.

FIG. 7. An illustration of an embodiment of the invention where an OMDR object, in this case a QR code, is affixed or otherwise included on an inside page of a lyric booklet.

### DETAILED DESCRIPTION OF THE DRAWINGS

Embodiments provide for the following method and system:

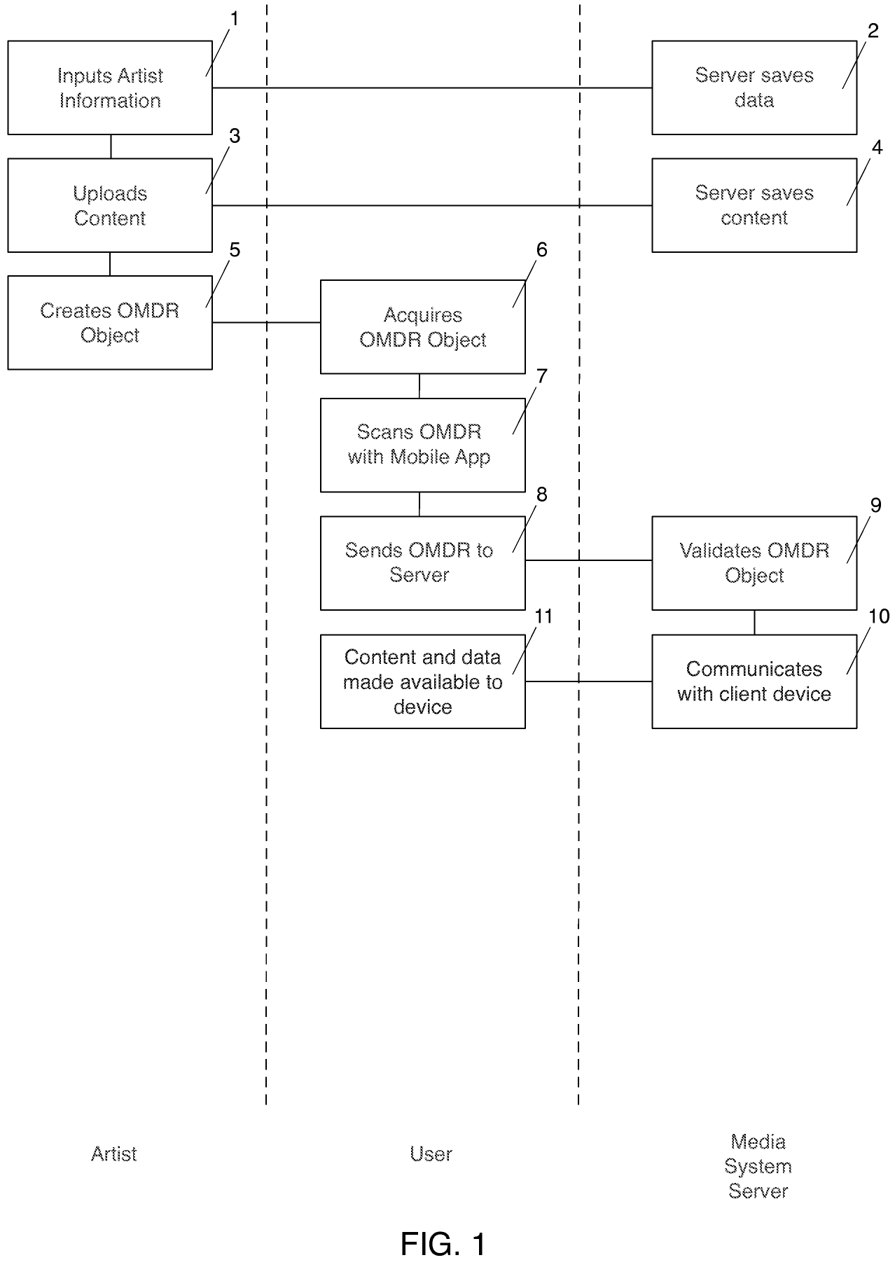

FIG. 1 depicts a conceptual diagram of a method and system of the invention. The artist (or content owner or their agent) inputs artist information including the artist name and associated information relevant to the digital content to be uploaded 101. The artist then uploads the content 103 via the computer application. The artist information 101 and associated content uploaded 103 are saved to the media system server 102, 104 to be made available to users later on. The artist then creates OMDR objects to display to users 105. At this point these objects may be governed by limitations and parameters as specified in the embodiments of this invention.

When an OMDR object 105 is made available to the user, the user may buy or otherwise acquire an object affixed to or included with a physical item, or otherwise made visible to the user 106. Having installed the mobile application (which we will call the “mobile app” for short) on a mobile device including a smart phone or tablet, the user utilizes the mobile app's scanning capability enabled through the camera on the mobile device hosting the mobile app to scan an OMDR object 107. The mobile app sends identifying data associated with the OMDR object to the media system server 108 where the object is matched against the server database 109 containing the content uploaded in previous steps 101, 102, 103 and 104. If a match is found and all parameters specified by the artist are met, the server validates the OMDR object 109. Once validated, the server communicates with the user's mobile device via the mobile application 110 wherein the digital content is made available to the said mobile device via the mobile app, including by download transfer 111.

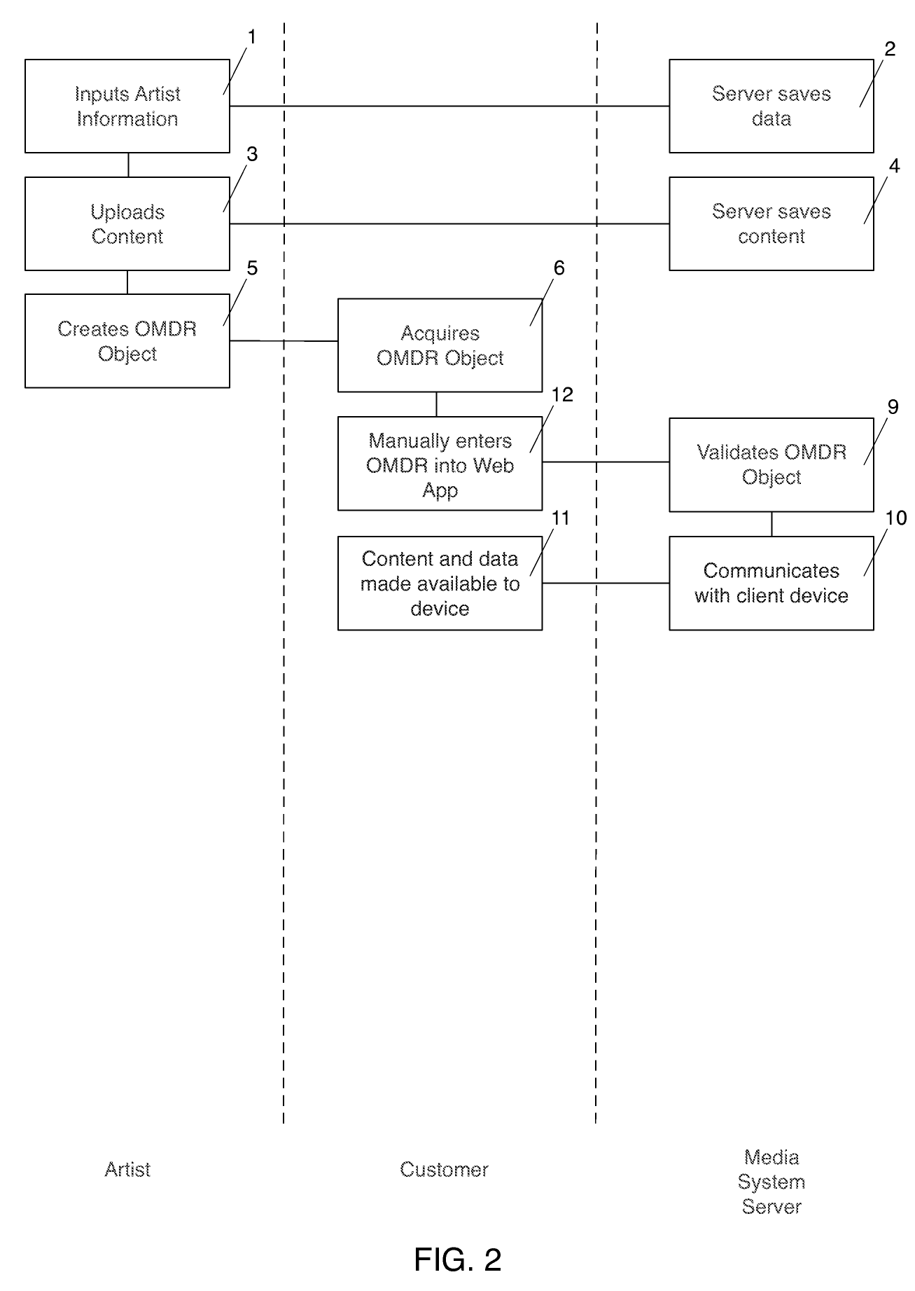

FIG. 2 depicts a conceptual diagram of a method and system of the invention for when the user lacks a mobile device compatible with the mobile application. FIG. 2 is identical to FIG. 1 in all respects except for 212 where the user manually enters a code located on the OMDR object into a web application. Manual entry of an alphanumeric code listed on the OMDR object or otherwise included on the object where the object is affixed or otherwise included kicks off the same process in FIG. 1 where the code is validated against the media system server database 209, which upon validation communicates with the client device, including a laptop computer, tablet or mobile device 210. After this process is complete, the data and content are made available to the user's device, including by download transfer 211. Thus, in this embodiment, the user may acquire content associated with an OMDR object even when they lack a compatible mobile computer device.

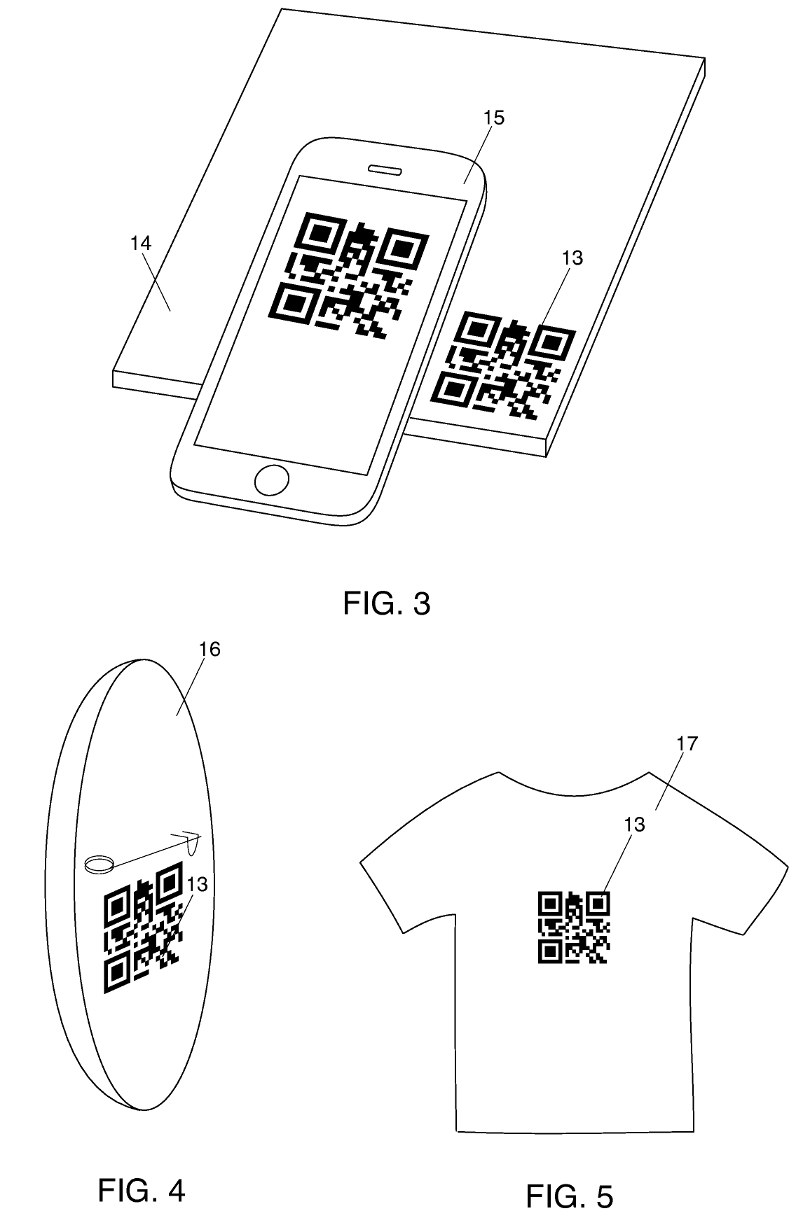

FIG. 3 is an illustration of an embodiment of a method and system of the invention wherein the OMDR object 313 is affixed to or otherwise included on the exterior of an object sold to a user, in this case a vinyl record jacket 314. The illustration shows the OMDR object, in this case a QR code 313, revealed on the front of the jacket 314 though the object may alternatively be placed anywhere on the jacket, included on the inside of the record jacket, on jacket packaging or otherwise obscured on the outside of the jacket prior to purchase in order to ensure that users purchase the record or similar item before they are able to acquire the associated digital content. The user, having already installed the mobile application on their mobile device, in this case a smart phone 315, uses the mobile application to leverage the camera of the mobile device to recognize the QR code 313. Recognition of the QR code results in the code being compared to data stored the media system server. If the code matches data stored in the server and the parameters set by the artist, content owner or their agents, the mobile application on the mobile device 315 is enabled to have access to said digital content, including by download.

FIG. 4 is an illustration of an alternative embodiment where the OMDR object, in this case a QR code 413, is affixed to or included in the reverse side of a button 416. The front side of the button 416 may include paraphernalia related to a musical artist, including band artwork. The QR code 413 could alternatively be affixed or otherwise included in any number of ways on the button, including on the front side. The button 416 could be sold by the artist, content owner or their agents to a user who, having a mobile computing device wherein the mobile application had been installed, could acquire the digital content associated with the OMDR object 413 using the mobile application as described in the embodiment depicted in FIG. 1.

FIG. 5 is another alternative embodiment where the digital content is sold as part of a t-shirt 517. The t-shirt 517 may include the OMDR object, in this case a QR code 513, via screen printing, iron-on transfers, a sticker or any number of other methods. The OMDR object 513 may be affixed or otherwise included on the front or back of the t-shirt 517, or alternatively on the interior, on the t-shirt tag or as part of packaging. Inclusion of the OMDR object 513 in these manners allows the artist, content owner or their agents to sell the digital content as part of selling the physical paraphernalia, in this case a t-shirt 517.

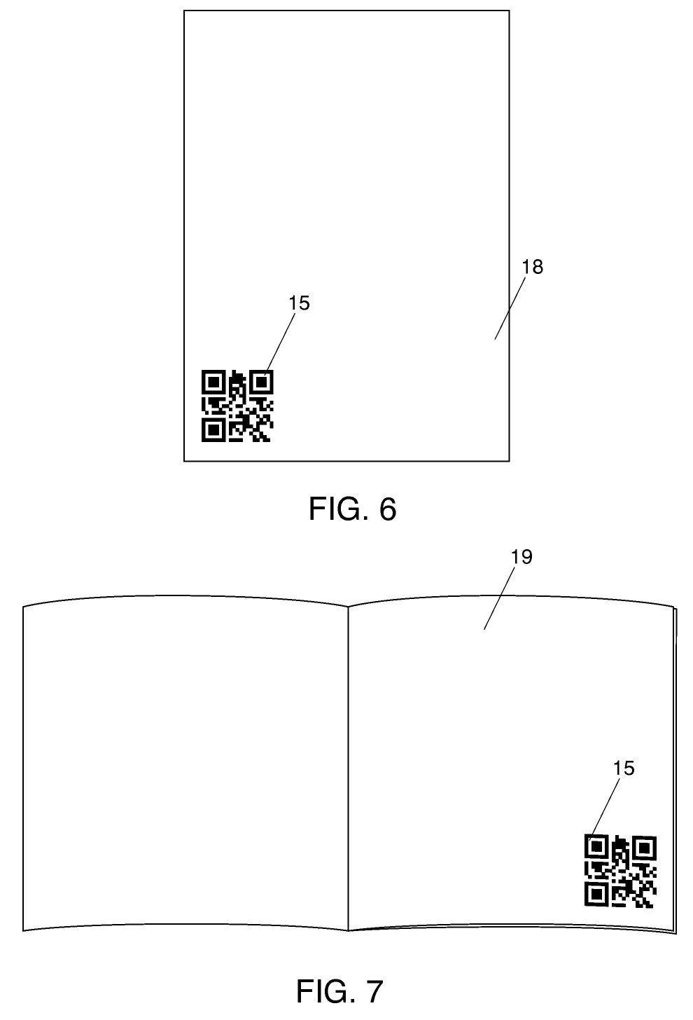

FIG. 6 depicts another alternative embodiment of the invention where an OMDR object, in this case a QR code 615 is shown affixed or otherwise included on the outer cover of a booklet, including a booklet containing the lyrics to an album, pictures, or a work of literature 618. The OMDR object 615 may alternatively be obscured as to prevent users from accessing the digital content associated with the OMDR object without legally acquiring the booklet.

FIG. 7 depicts an inside page of the booklet depicted in FIG. 6 719, with the OMDR object 715 this time included on an inside page of the booklet 719. This embodiment has the advantage, if the booklet were to be shrink-wrapped or otherwise packaged, of naturally hiding the code until purchase of the booklet. Furthermore, in this embodiment, the OMDR object 715 may be included as a part of artwork on the pages.

Accordingly, the scope of this invention and its embodiments should not be limited by the above specifications but rather by the claims listed in this patent and their legal equivalents.

I claim:

1. A method of utilizing a media system server and computer and mobile related applications to facilitate the requesting and accessing of digital media comprising:
a. a media system server means to store digital media and associated data, validate OMDR objects and distribute digital content to users, configured to send and receive media and associated information to and from a computer application and a mobile device application;
b. an internet-based computer application means configured to allow artists, owners of digital media and their agents to create optical machine-readable data representations (OMDR objects) linked to said digital media for presentation to users;
c. visual means to display any number of OMDR objects, including physical means;
d. a mobile device means for operating the mobile computer application, including smart phones and tablets; and
e. a mobile computer application means to recognize OMDR objects, send OMDR object data to the media system server for validation, allow access to said digital media and play, view, transfer or otherwise interact with acquired media.

2. The method of claim 1 comprises the visual means of element C of claim 1, wherein the means is comprised of any number unique OMDR objects associated with digital media.

3. The method of claim 1 comprises the visual means of element C of claim 1, wherein the means is comprised of any number of copies of a single OMDR object associated with digital media.

4. The method of claim 1 comprises the visual means of element C of claim 1, wherein providing an internet-based computer application and media system server means to limit access to digital media to any number of users, including by prohibiting any number of devices from accessing digital media associated with a single OMDR object.

5. The method of claim 1 comprises the visual means of element C of claim 1, wherein providing an internet-based computer application and media system server means to prohibit access to digital media by specifying that a mobile device must be in a particular geography to access media associated with any number of OMDR objects.

6. The method of claim 1 comprises the visual means of element C of claim 1, wherein providing an internet-based computer application and media system server means to limit access to digital media by specifying a time period in which users may access media associated with any number of OMDR objects.

7. The method of claim 1 comprises the visual means of element E of claim 1, wherein providing digital media library means for organizing and using media.

8. 5. The method of claim 1 comprises the visual means of element E of claim 1, wherein the functions of the computer application of element B of claim 1 are fulfilled all or in part by the mobile computer application of element E of claim 1.
